(19) United States
(12) Patent Application Publication
(10) Pub. No.: US 2016/0071227 A1
(43) Pub. Date: Mar. 10, 2016

(54) Transaction Systems and Methods for Travelers Using Mass-Transit Vehicles and Facilities

(71) Applicant: MASTERCARD INTERNATIONAL INCORPORATED, Purchase, NY (US)

(72) Inventors: Kiran Shenoy, O'Fallon, MO (US); Mandeep Sandhu, O'Fallon, MO (US); Anthony Cooper, O'Fallon, MO (US); Jared Boucher, O'Fallon, MO (US)

(21) Appl. No.: 14/481,404

(22) Filed: Sep. 9, 2014

(51) Int. Cl. G06Q 50/30; G06Q 30/06; G06Q 20/14

(52) U.S. Cl. CPC G06Q 50/30; G06Q 20/14; G06Q 30/0611; G06Q 30/0633

(57) ABSTRACT

A mobile communication device transaction systems and methods for travelers using mass-transit vehicles and facilities are disclosed. Exemplary servers are for connection to a mobile communication device that includes a travel transaction application identifying at least one traveler, payment information, and trip information. The servers receive the traveler, payment information, and trip information and define at least one traveler product purchase offer, based on the traveler and the trip information. The servers further cause the traveler product purchase offer to be sent to the mobile communication device travel transaction application for display on the mobile communication device. The servers also cause a payment transaction to be made using the identified payment information after the servers receive a purchase order from the mobile communication device for the traveler product purchase offer.

### FIELD

The present disclosure relates to a mobile communication device transaction system. More specifically, the present disclosure is for use by travelers using mass-transit vehicles and facilities to make purchases while traveling.

### BACKGROUND

This section provides background information related to the present disclosure which is not necessarily prior art.

The ability of a mobile communication device such as a cellular phone, a laptop computer, a tablet, or other electronic device to implement a transaction, such as a purchase of products or services, is well known. More specialized types of marketing or sales are also known, such as location-based advertisements for restaurants and shops near the current location of the mobile device.

However, the ability of a traveler to make purchases during travel on mass-transit vehicles and through facilities such as airports, train stations, subway terminals, bus depots, ship harbors, or the like is inconvenient and can turn on the ever changing time schedule of the mass-transit vehicles. For example, air travel changes are a common occurrence and include changes in arrival and departure times, gate arrivals and departures, and flight cancellations that may be caused by a variety of issues such as weather delays, mechanical issues, etc. Furthermore, the ability of a traveler to make purchases on-board an airplane is limited by the product storage space of the airplane, the time available to the crew for selling products, and the need for handling the financial transaction.

### DRAWINGS

The drawings described herein are for illustrative purposes only of selected embodiments and not all possible implementations, and are not intended to limit the scope of the present disclosure.

FIG. 1 is an exemplary system for a mobile communication device transaction system;

FIG. 2 is a flowchart of an exemplary logic flow for an example of a mobile communication device transaction system; and

FIG. 3 is a flowchart of an exemplary logic flow for another example of a mobile communication device transaction system.

Corresponding reference numerals indicate corresponding parts throughout the several views of the drawings.

### DETAILED DESCRIPTION

Example embodiments will now be described more fully with reference to the accompanying drawings.

The examples below provide a traveler with a transaction system for conveniently purchasing products and services available on-board mass-transit vehicles and from merchants at mass-transit facilities through which the traveler will pass during a trip. The examples are beneficial to the traveler, mass-transit companies, and merchants. The examples below provide a convenient forum for a financial transaction, allow the traveler to make on-board purchases prior to and/or during a trip (and/or even after the trip), and allow the mass-transit companies and merchants to make product offerings compatible with a traveler's trip information, including updated trip information during travel. It is noted that the use of the term product or products should be construed to include services in addition to goods.

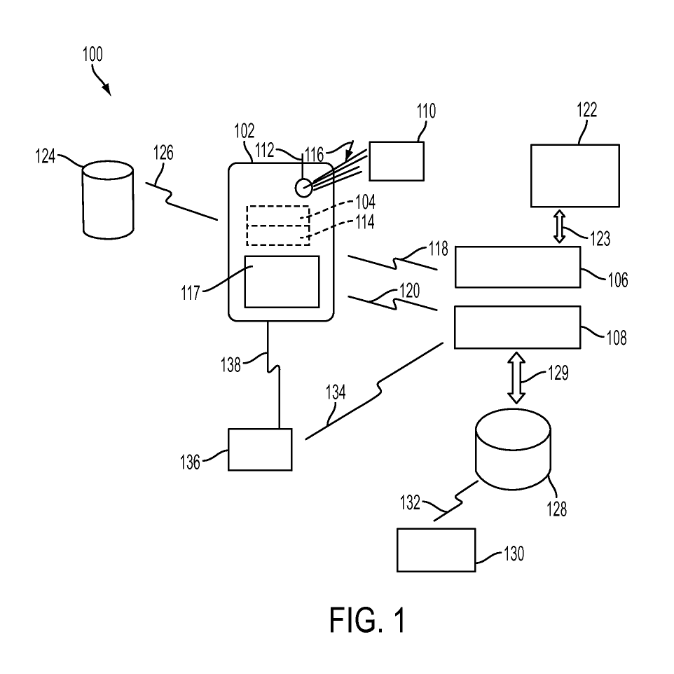

FIG. 1 is an example of a mobile communication device transaction system 100 for travelers using mass-transit vehicles and facilities. The mass-transit vehicles may be, for example, any type of vehicle that transports many people at a time, such as airplanes, trains, subway trams, buses, ships, ferries, or the like. Similarly, examples of the mass-transit facilities may be airports, train stations, subway stations, bus depots, harbors, docks, etc. The following example is with respect to airplane travel but may be equally applicable to other mass-transit vehicles and facilities.

Currently there are no known systems available allowing travelers to pre-order inflight products and services such as food, drinks, movies, WiFi, pillows, blankets, etc. The example transaction system below can be used by mass-transit companies and merchants to learn and better understand traveler's wants and needs during a trip. The examples below also allow travelers to create a wish list of items that may further aid an airline in planning its future product and service offerings and perhaps even personalize such offerings to the traveler. The examples below even further provide the airlines with a convenient forum for updating trip information to the traveler, such as delays, gate changes, cancellations. Conveniently, the updated trip information may provide a purchase offer opportunity for the airline or other merchants. For example, if an unexpected delay occurs, the airline may offer access to a lounge at the airport for those travelers experiencing the delay. The airline may receive payment for this access and the traveler will have a more comfortable place to be during the delay. Of course other possible product offerings may include flight upgrade offers, or facility merchants may offer products such as duty free products, catalog shopping, or services such as haircuts, massages, beauty services, or entertainment during a layover or delay.

The examples below may also save the inflight crew from the need to be concerned with cash or a traveler's payment account, by automatically setting up payment in the system for any products or services purchased.

Returning to FIG. 1, a mobile communication device 102 includes first computer-executable instructions defining a travel transaction application 104. The application 104 is shown as a dashed rectangle within device 102 and may include any appropriate application or program to be used with the mobile communication device 102. The application 104 identifies at least one traveler, payment information, and trip information. The information may be input to the application 104 by any appropriate method, including manually typing the information into the appropriate fields (not shown) or via scanning a ticket 110 with a camera 112 of the device 102. The camera 112 may cooperate with a camera interface 114 (shown as a dashed rectangle) to read a bar code or other graphical code (as represented by lines at 116) and automatically fill the appropriate fields of the application 104. Other types of scanning or reading may also be used as appropriate, such as radio-frequency identification, optical character recognition, or other appropriate technology. In at least one embodiment, the information is input into device 102, by a combination of manual typing and scanning.

Further, the first computer-executable instructions defining the travel transaction application 104 may include instructions allowing a traveler to identify a product, to select product(s) from a product purchase offering (described below), and/or to create a wish list for products desired during travel.

One or more servers 106, 108 are for connection to the mobile communication device 102. The servers 106, 108 may themselves be one or more servers with appropriate computer-executable instructions and associated memory and storage, as is well known. The one or more servers 106, 108 receive the at least one identified traveler, the payment information, and the trip information and include second computer-executable instructions defining at least one traveler product purchase offer based on the at least one identified traveler and the trip information. The one or more servers 106, 108 may be servers of an airline, or of a payment services company such as MasterCard® or of a partner merchant, such as a merchant in an airport.

The product offerings can be wide ranging, including on-board offerings mentioned above or other products that a traveler may wish to purchase for use at a new destination or gifts for family when traveling home.

The one or more servers 106, 108 include further computer-executable instructions causing the at least one traveler product purchase offer to be sent to the mobile communications device 102 travel transaction application 104 for display on the mobile communication device 102 at display 117. The information may be sent between the device 102 and one or more servers 106, 108 via wireless links represented by 118, 120 or by any appropriate connection such as wires, infra-red, cellular, or WiFi links.

The one or more servers 106, 108 include still further computer-executable instructions causing a payment transaction to be made using the identified payment information after the one or more servers 106, 108 receive a purchase order from the mobile communication device 102 for the at least one traveler product purchase offer. For example, the server 106 may be part of a payment services network such as MasterCard®, which will take the payment information, such as a primary account number (PAN) belonging to the traveler, cause the traveler's account to be charged or debited for an amount of the purchase order, and further cause the merchant's account to be credited with the amount of the purchase order, less any applicable fees through the payment network 122.

The one or more servers 106, 108 may be configured to store a transaction history for the at least one identified traveler and share the transaction history with at least one partner merchant for presenting the identified traveler a purchase offer based on the transaction history, i.e., a transaction history offer. The transaction history may be stored in a database 124 with the transaction history sent from the mobile communication device 102 via communication link 126, as shown, or from the one or more servers 106, 108. The partner merchant is not shown in FIG. 1. Also, not shown, are application views and data that may be sent from any of the servers 106, 108, or the databases 124, 128 to a partner merchant or a mass-transit company, identifying product offerings, inventory lists for stocking the mass-transit vehicles with pre-ordered products, and listings of the delivered products based on any appropriate criteria, such as per trip, per individual, per type of travel ticket purchased, per the time of day of travel, per destination, per origination, etc.

With further reference to FIG. 1, the second computer-executable instructions of the one or more servers 106, 108 may further include instructions causing the one or more servers 106, 108 to send a purchase confirmation to a relevant merchant and to the at least one identified traveler. The purchase confirmation may be in the form of one or more of an email, an SMS message, or other message sent to the device 102 or to another location designated by the traveler or merchant. Further, the mobile communication device 102 may store, in memory, the purchase confirmation.

In order to provide the traveler with a greater array of desired product offers, the second computer-executable instructions of the one or more servers 106, 108 may further include instructions causing the one or more servers 106, 108 to share the identified at least one traveler and the trip information with at least one partner merchant server 130. This sharing of information could be done via a database 128 over data link 129 that is accessible by the partner merchant server 130 over a communication link 132.

Depending on the traveler's trip information, it is possible that the system could enable delivery of purchased products to the traveler during the trip. The second computer-executable instructions of the one or more servers 106, 108 may further include instructions establishing a product delivery to the identified at least one traveler in at least one of the mass-transit vehicles and the mass-transit facility from a partner merchant. The second computer-executable instructions may further cause the one or more servers 106, 108 to determine, based on the identified trip information, if there is sufficient time for the product delivery and may further cause the one or more servers 106, 108 to send the identified at least one traveler a message identifying a time and a place of the product delivery and if the one or more servers 106, 108 determine there is not sufficient time for product delivery, sending the identified at least one traveler a message that the product delivery is not available.

As mentioned above, the system may also allow the airline or other partner merchant to provide product offers based on updated trip information. The second computer-executable instructions of the one or more servers 106, 108 may further include instructions for periodically updating the identified trip information. At least one mass-transit facility merchant (including the mass-transit company such as the airline) sends product offers via the one or more servers 106, 108 to the mobile communication device 102 based on at least the updated identified trip information. The updated identified trip information may include an unexpected delay, giving merchants a chance for sales to the traveler that they may not have had without the updated trip information. The second computer-executable instructions of the one or more servers 106, 108 for periodically updating the identified trip information may include instructions causing the one or more servers 106, 108 to send the updated identified trip information to the mobile communication device 102.

The one or more servers 106, 108 may also include computer-executable instructions causing information of the on-board products purchased by the traveler to be sent to the flight crew over communication link to an appropriate device 136, such as a tablet or other vending device. The flight crew can then confirm delivery of the purchased products at device 136 with a confirmation sent to the mobile device from server 108 or from device 136 via communication link 138.

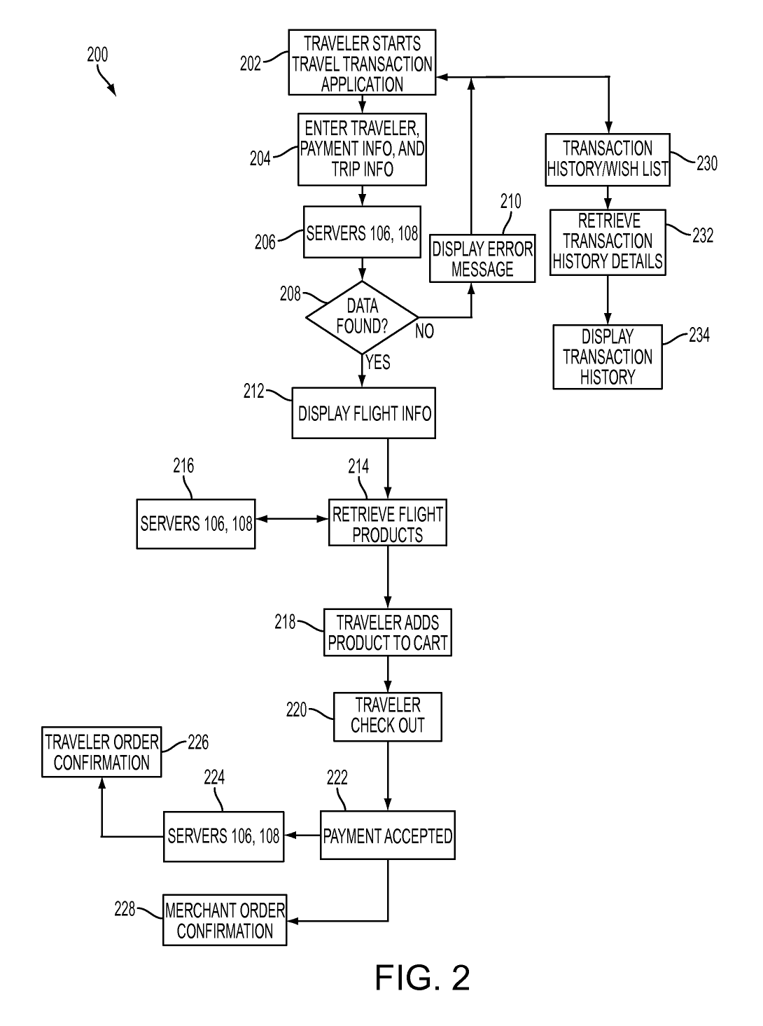

FIG. 2 is example logic flow 200 of a computer-implemented method for a mobile communication device transaction for travelers using mass-transit vehicles and facilities. A traveler starts the travel transaction application that is in the mobile communication device 102, at step 202, and enters the traveler, payment information, and the trip information into the travel transaction application, at step 204. The method includes receiving and storing information at steps 202, 204 from a mobile communication device 102, at one or more servers in step 206. The received information identifies at least one traveler, payment information, and/or trip information. It will be appreciated that in some embodiments, the payment information may only be entered into the travel transaction application of mobile communication device 102 once, until the payment information is no longer valid or different payment information is to be used. Similarly, in various embodiments, the owner or user of the mobile communication device 102 may only enter his name once, though additional travelers may be added, as appropriate for trips.

The one or more servers 106, 108 attempt to find matching data at step 208. For example, servers 106, 108 may check an airline's flight records for names matching the identified traveler on a flight number corresponding to the date and times received from the information entered in step 204. If step 208 cannot find data matching the information received from step 204, step 210 causes an appropriate error message to be displayed on the mobile communication device 102 and loops back to step 202.

If step 208 find matching data, step 212 causes the current flight information to be displayed on the mobile communication device 102. The flight information can include the current estimated departure time, the departure gate, the type of aircraft, etc.

The method continues by sending, via the one or more servers 106, 108, at least one traveler product purchase offer at step 214 to the mobile communication device 102. The traveler product purchase offer is generated by computer-executable instructions in the one or more servers 106, 108 based on the at least one identified traveler and the trip information received at step 206. The types of product purchase offers are broad and include those mentioned above. The traveler, at step 218 adds one or more products to a virtual cart, as is known.

The method includes making a payment transaction using the identified payment information, via further computer-executable instructions in the one or more servers, after the one or more servers receive a purchase order from the mobile communication device 102 for the at least one traveler product purchase offer at steps 220-224. Specifically, the traveler checks out at step 220 and the one or more servers 106, 108 accept payment at steps 222 and 224, after confirming that the payment information is correct and valid and that the transaction is authorized. Step 224 also causes servers 106, 108 to send the traveler an order confirmation. The order confirmation can be sent to any acceptable destination such as the traveler's email account, a SMS message to the mobile communication device 102, or even a letter sent to a traveler's home or office. Servers 106, 108 also send an order confirmation to the merchant at step 228.

In some aspects, instructions may also be sent by the mass-transit companies and/or the merchants, following such transaction by the traveler (or after a particular number of such transactions), to evaluate product supply. And, if the evaluation indicates that the product supply is low or below a predefined threshold, further instructions may be sent by the mass-transit companies and/or the merchants to adjust the product supply as needed to help ensure future transactions can be accommodated.

In some additional aspects, instructions may be sent by the mass-transit companies and/or the merchants, following such transactions, to update a listing of products for delivery (to allow for monitoring, tracking, etc. delivery of the products to the travelers). In some aspects, the listing of products for delivery may be sent to the mass-transit vehicles, as appropriate, to help facilitate accurate delivery of the products.

The method may further include storing, in a memory associated with the one or more servers 106, 108 a transaction history for the at least one identified traveler at step 230, the one or more servers 106, 108 having computer-executable instructions causing the transaction history to be shared with at least one partner merchant, which permits the merchant to present the identified traveler a purchase offer based on the transaction history. Step 232 causes the one or more servers 106, 108 to retrieve the transaction history details and step 234 causes the transaction history details to be displayed on the mobile communication device 102 or at a partner merchant.

The method may further include utilizing computer-executable instructions defining a travel transaction application in the mobile communication device 102, including instructions enabling a camera 112 of the mobile communication device 102 to scan a travel ticket 110 to identify the at least one traveler and the trip information.

The method may further include offering products and services available on-board the mass-transit vehicle, such as an airplane, as described above.

The method at step 230 may further include computer-executable instructions allowing the traveler to create a wish list for products desired during travel and storing the wish list in a memory, such as database 124, associated with the one or more servers 106, 108.

As described above at steps 224-228, the method may further include computer-executable instructions in the one or more servers 106, 108 for sending a purchase confirmation to a relevant merchant and to the at least one identified traveler.

The method may further include computer-executable instructions in the one or more servers 106, 108 for sharing the identified at least one traveler and the trip information with at least one partner merchant server 130.

In some aspects, the method may also include computer-executable instructions in the one or more servers 106, 108 for use by mass-transit companies and/or merchants to monitor and/or configure product supplies (e.g., to refresh product supplies, adjust product supplies based on demand, etc.). In so doing, the instructions may also allow the mass-transit companies and/or merchants to compile inventory lists for supplying/loading mass-transit vehicles and/or merchant locations within mass-transit facilities, and/or per-trip listings of products for delivering (e.g., facilitating delivery, coordinating delivery, monitoring delivery, etc.) the products to the travelers. Here, various application views may be provided (e.g., for display on computing devices, etc.) for use by the mass-transit companies and/or merchants to facilitate such actions.

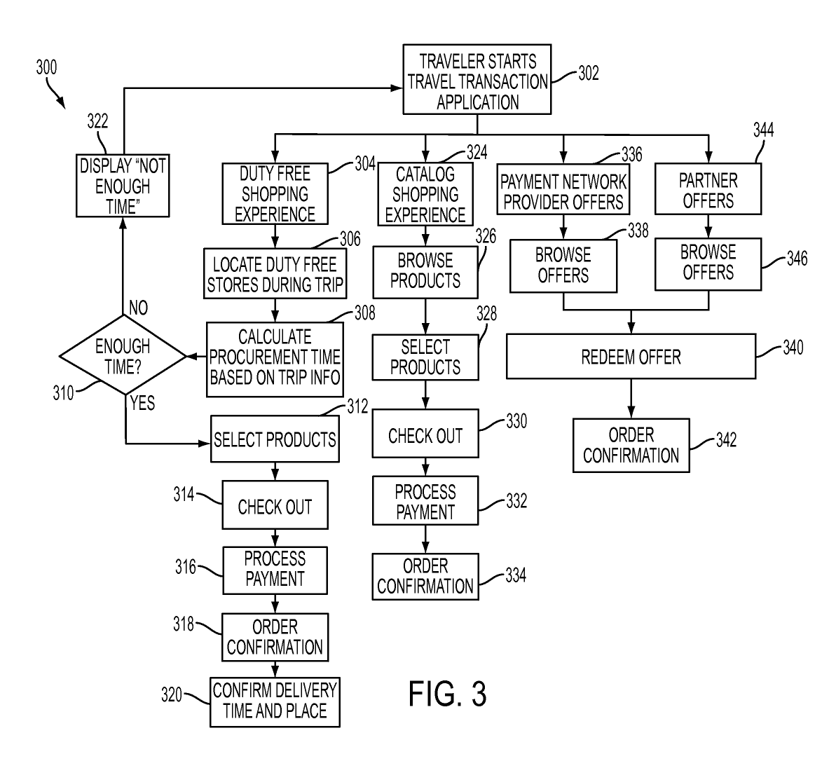

FIG. 3 is example logic flow 300 for other possible configurations of the system and methods disclosed. A traveler starts the travel transaction application on the mobile communication device at step 302. Several possible transactions will be described below.

The method may further include computer-executable instructions in the one or more servers 106, 108 establishing a product delivery to the identified at least one traveler in at least one of the mass-transit vehicles and the mass-transit facility from a partner merchant at steps 304-320. The computer-executable instructions further cause the one or more servers 106, 108 to determine, based on the identified trip information at step 308, if there is sufficient time for the product delivery at step 310 and still further causing the one or more servers 106, 108 to send the identified at least one traveler a message identifying a time and a place of the product delivery at step 320 and if the one or more servers 106, 108 determine, at step 310, there is not sufficient time for product delivery, sending the identified at least one traveler a message that the product delivery is not available, at step 322. More specifically, at step 304, the traveler selects to browse, in this example, a duty free shopping experience. Step 306 then causes the one or more servers 106, 108 to locate duty free stores corresponding to the trip information. Step 308 calculates the procurement time necessary based on the trip information. If step 310 determines there is enough time for the traveler to procure items from the store, the method proceeds to step 312 where the traveler selects products to purchase. Steps 314 and 316 complete the payment process, similarly to that described above. Step 318 causes order confirmations to be sent to the traveler and to the duty free store from which products are purchased. Finally, step 320 confirms a time and place of delivery (e.g., at the airplane, or within the airplane (by a flight attendant), etc.) or pick-up of the purchased items.

Steps 324-334 set forth a similar process to that described with respect to the duty free store. The difference is that steps 324-334 are applicable to a catalog shopping experience, such as purchasing products from SkyMall™. The steps 324-334 include steps for browsing and selecting products, paying for the products, and sending order confirmations to the catalog merchant and the traveler.

Step 336 is an example of a payment network provider presenting offers to the traveler through the travel transaction application. A payment network provider, such as MasterCard®, presents offers at step 336 and the traveler browses the offers at step 338. Any offers that the traveler wants to redeem are identified at step 340 and the redemption order is confirmed to the traveler and to the payment network provider at step 342. Similarly, step 344 is an example of a partner merchant presenting the traveler with offers. The traveler browses the offers at step 346 and any offers that the traveler wants to redeem are identified at step 340. Again, order confirmations are sent, at step 342, to the partner merchant and the traveler.

The method may also further include computer-executable instructions in the one or more servers 106, 108 for periodically updating the identified trip information and wherein at least one mass-transit facility merchant sends product offers via the one or more servers 106, 108 to the mobile communication device 102 based on at least the updated identified trip information. As described above, the product offers based on the updated trip information may include offers for use of an airline's lounge, or for products and services that would not have been available but for the updated information.

The method may also further include computer-executable instructions in the one or more servers 106, 108 causing the updated identified trip information to be sent to the mobile communication device 102, thus keeping the traveler up-to-date.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving and storing information from a mobile communication device, at one or more servers, the received information identifying at least one traveler, payment information, and trip information, (b) sending, via the one or more servers, at least one traveler product purchase offer to the mobile communication device, wherein the traveler product purchase offer is generated by computer-executable instructions in the one or more servers based on the at least one identified traveler and the trip information, and (c) making a payment transaction using the identified payment information, via further computer-executable instructions in the one or more servers, after the one or more servers receive a purchase order from the mobile communication device for the at least one traveler product purchase offer.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mobile communication device transaction system for travelers using mass-transit vehicles and facilities comprising:
one or more servers for connection to a mobile communication device, wherein the mobile communication device includes first computer-executable instructions defining a travel transaction application for identifying at least one traveler, payment information, and trip information,
wherein the one or more servers includes second computer-executable instructions that, when executed, cause the one or more servers to:
receive, from the mobile communication device, the at least one identified traveler, payment information, and trip information;
define at least one traveler product purchase offer based on the at least one identified traveler and the trip information;
send the at least one traveler product purchase offer to the travel transaction application for display on the mobile communication device; and
make a payment transaction using the identified payment information after the one or more servers receive a purchase order from the mobile communication device for the at least one traveler product purchase offer.

2. The transaction system of claim 1, wherein the one or more servers are configured to store a transaction history for the at least one identified traveler and to share the transaction history with at least one partner merchant, thereby permitting the at least one partner merchant to present the identified traveler a purchase offer based on the transaction history.

3. The transaction system of claim 1, wherein the first computer-executable instructions defining the travel transaction application further include instructions utilizing a camera of the mobile communication device for scanning a travel ticket to identify the at least one traveler and the trip information.

4. The transaction system of claim 1, wherein the at least one traveler product purchase offer includes offers for products available on-board the mass-transit vehicle.

5. The transaction system of claim 1, wherein the first computer-executable instructions defining the travel transaction application further include instructions allowing the traveler to create a wish list for products desired during travel.

6. The transaction system of claim 1, wherein the second computer-executable instructions of the one or more servers further includes instructions that, when executed, cause the one or more servers to send a purchase confirmation to a relevant merchant and to the at least one identified traveler.

7. The transaction system of claim 1, wherein the second computer-executable instructions of the one or more servers further includes instructions that, when executed, cause the one or more servers to share the identified at least one traveler and the trip information with at least one partner merchant server.

8. The transaction system of claim 1, wherein the second computer-executable instructions of the one or more servers further includes instructions that, when executed, cause the one or more serves to:
establish a product delivery to the identified at least one traveler in at least one of the mass-transit vehicles and the mass-transit facility from a partner merchant,
determine, based on the identified trip information, if there is sufficient time for the product delivery;
send the identified at least one traveler a message identifying a time and a place of the product delivery and if the one or more servers determine there is not sufficient time for product delivery; and
send the identified at least one traveler a message that the product delivery is not available.

9. The transaction system of claim 1, wherein the second computer-executable instructions of the one or more servers further includes instructions that, when executed, cause the one or more servers to:
periodically update the identified trip information; and
send at least one product offer from at least one mass-transit facility merchant to the mobile communication device, via the one or more servers, based on at least the updated identified trip information.

10. The transaction system of claim 9, wherein the second computer-executable instructions of the one or more servers further includes instructions that, when executed, cause the one or more serves to send the updated identified trip information to the mobile communication device.

11. A computer-implemented method for a mobile communication device transaction for travelers using mass-transit vehicles and facilities, the method comprising:
receiving and storing information from a mobile communication device, at one or more servers, the received information identifying at least one traveler, payment information, and trip information;
sending, via the one or more servers, at least one traveler product purchase offer to the mobile communication device, the traveler product purchase offer based on the at least one identified traveler and the trip information; and
making a payment transaction using the identified payment information, via the one or more servers, after the one or more servers receive a purchase order from the mobile communication device for the at least one traveler product purchase offer.

12. The method of claim 11 further comprising storing in a memory associated with the one or more servers a transaction history for the at least one identified traveler, and sharing at least a portion of the transaction history with at least one partner merchant for presenting the identified traveler a purchase offer based on the transaction history.

13. The method of claim 11 further comprising receiving the at least one traveler product purchase offer, from the at least one partner merchant, based on the transaction history.

14. The method of claim 11, further comprising offering products and services available on-board the mass-transit vehicle.

15. The method of claim 11 further comprising receiving a traveler wish list from the mobile communication device, for products desired during travel; and
storing the wish list in a memory associated with the one or more servers.

16. The method of claim 11 further comprising sending a purchase confirmation to a relevant merchant and to the at least one identified traveler.

17. The method of claim 11 further comprising sharing the identified at least one traveler and the trip information with at least one partner merchant server.

18. The method of claim 11 further comprising establishing a product delivery to the identified at least one traveler in at least one of the mass-transit vehicle and the mass-transit facility from a partner merchant;
determining, based on the identified trip information, if there is sufficient time for the product delivery; and
sending the identified at least one traveler a message identifying a time and a place of the product delivery.

19. The method of claim 11 further comprising periodically updating the identified trip information; and
wherein sending the at least one traveler product purchase offer includes sending the at least one traveler product purchase offer from at least one mass-transit facility merchant, via the one or more servers, based on at least the updated identified trip information.

20. The method of claim 19 further comprising updating identified trip information to be sent to the mobile communication device.
